(19) United States
(12) Patent Application Publication
(10) Pub. No.: US 2011/0077311 A1
(43) Pub. Date: Mar. 31, 2011

(54) METHOD FOR HANDLING VISCOUS LIQUID CRUDE HYDROCARBONS

(75) Inventors: Estrella Rogel, Orinda, CA (US); Cesar Ovalles, Walnut Creek, CA (US)

(73) Assignee: Chevron U.S.A. Inc.

(21) Appl. No.: 12/566,881

(22) Filed: Sep. 25, 2009

(51) Int. Cl. B01D 17/05

(52) U.S. Cl. 516/141

(57) ABSTRACT

A method for handling viscous liquid crude hydrocarbons is disclosed. The method involves (a) obtaining an emulsion comprising an aqueous fraction and a liquid crude hydrocarbon fraction, wherein the liquid crude hydrocarbon fraction has a first viscosity and contains an oil-soluble compound that reversibly converts to a surfactant under basic conditions, and further wherein the emulsion has a second viscosity that is less than the first viscosity of the liquid crude hydrocarbon fraction; and (b) breaking the emulsion by contacting the emulsion with a carbon dioxide-containing material to convert at least a portion of the surfactant to the oil-soluble compound.

### BACKGROUND OF THE INVENTION

1. Technical Field

The present invention generally relates to a method for handling viscous liquid crude hydrocarbons.

2. Description of the Related Art

Hydrocarbon fluids, such as oil and natural gas, and other desirable formation fluids are generally obtained from a subterranean geologic formation, i.e., a reservoir, by, for example, drilling a well that penetrates the formation zone that contains the desired fluid. Once a wellbore has been drilled, the well must be completed. A well “completion” involves the design, selection, and installation of equipment and materials in or around the wellbore for conveying, pumping, or controlling the production or injection of fluids. After the well has been completed, production of the formation fluids can begin.

The large reserves of crude hydrocarbons exist which, in their natural state, are very viscous. However, the viscous nature of the crude hydrocarbons makes it difficult to transport the hydrocarbons in conventional pipelines to stations where the viscous crude hydrocarbons can be processed into useful end products. One solution to the problem of transporting viscous crude hydrocarbons has been to form oil-in-water emulsions. Oil-in-water emulsions exhibit greatly reduced viscosity which facilitates its transport through a pipeline.

Surfactants are typically used to form a stable emulsion in order to be able to transport the viscous crude hydrocarbons through the pipeline. A surfactant is a molecule that has one portion which is water-soluble (i.e., hydrophilic, lipophobic) and a second portion which is oil-soluble (i.e., hydrophobic, lipophilic). Due to this property of dual solubility, surfactants are able to stabilize emulsions because they bridge the interface between the oil and the water.

Once placed in an oil and water mixture, a surfactant orients itself so that its water-soluble portion is surrounded by water molecules and its oil-soluble portion is surrounded by oil molecules. The mixture is therefore more likely to remain as an emulsion in the presence of a surfactant than it is to separate into its two distinct layers. Thus, surfactants are used to stabilize an emulsion by preventing it from separating into distinct layers. Once the emulsion containing the viscous crude hydrocarbons has been transported to its desired destination, e.g., a treatment facility, the emulsion can optionally be broken so as to reform it according to more refined parameters for various end processing.

U.S. Pat. No. 4,392,944 (“the '944 patent”) discloses a stable oil-in-water emulsion of heavy crude oil and bitumen and subsequent breaking of the emulsion. The '944 patent discloses that the emulsion can be broken by conversion of the oil-in-water emulsion into a water-in-oil emulsion using calcium hydroxide (i.e., slaked lime or hydrated lime) and dewatering of the resulting water-in-oil emulsion.

U.S. Pat. No. 5,526,839 (“the '839 patent”) discloses a method for forming a stable emulsion of a viscous crude hydrocarbon in an aqueous buffer solution, involving the steps of (a) providing a viscous crude hydrocarbon containing an inactive natural surfactant; (b) forming a solution of a buffer additive in an aqueous solution to provide a basic aqueous buffer solution, wherein the buffer additive activates the inactive natural surfactant from the viscous crude hydrocarbon; and (c) mixing the viscous crude hydrocarbon with the aqueous buffer solution at a rate sufficient to provide a stable emulsion of the viscous crude hydrocarbon in the aqueous buffer solution.

It would be desirable to provide improved methods for handling and transporting viscous liquid crude hydrocarbons that can be carried out in a simple, cost efficient manner.

### SUMMARY OF THE INVENTION

In accordance with one embodiment of the present invention, there is provided a method for handling viscous liquid crude hydrocarbons, the method comprising the steps of:

(a) obtaining an emulsion comprising an aqueous fraction and a liquid crude hydrocarbon fraction, wherein the liquid crude hydrocarbon fraction has a first viscosity and contains an oil-soluble compound that reversibly converts to a surfactant under basic conditions, and further wherein the emulsion has a second viscosity that is less than the first viscosity of the liquid crude hydrocarbon fraction; and

(b) breaking the emulsion by contacting the emulsion with a carbon dioxide-containing material to convert at least a portion of the surfactant to the oil-soluble compound.

The method of the present invention advantageously breaks an emulsion comprising an aqueous fraction and a liquid crude hydrocarbon fraction wherein the liquid crude hydrocarbon fraction has a first viscosity and contains an oil-soluble compound that reversibly converts to a surfactant under basic conditions, and further wherein the emulsion has a second viscosity that is less than the first viscosity of the liquid crude hydrocarbon fraction, by contacting the emulsion with a carbon dioxide-containing material. In this manner, a viscous liquid crude hydrocarbon can be handled and transported in a simple, cost efficient method. In addition, the aqueous fraction of the emulsion absorbs the carbon dioxide-containing material thus preventing the carbon dioxide from emitting into the atmosphere. Accordingly, the method of the present invention is also environmentally friendly.

### BRIEF DESCRIPTION OF THE DRAWINGS

FIG. 1 is a graphical comparison of the effect of sodium carbonate concentration on emulsion viscosity, wherein the sodium carbonate concentration is plotted as ppm with respect to crude oil.

FIG. 2 is a graphical comparison of the effect of ethanolamine concentration on emulsion viscosity, wherein the ethanolamine concentration is plotted as ppm with respect to crude oil.

FIG. 3 is a bar graph comparing the emulsion viscosity of different water types in forming the aqueous phase of the emulsion.

FIG. 4 is a graphical comparison of the viscosity of the emulsion of Example 4 over time.

### DETAILED DESCRIPTION OF THE PREFERRED EMBODIMENTS

The present invention is directed to a method for handling viscous liquid crude hydrocarbons. Generally, the method involves (a) obtaining an emulsion comprising an aqueous fraction and a liquid crude hydrocarbon fraction, wherein the liquid crude hydrocarbon fraction has a first viscosity and contains an oil-soluble compound that reversibly converts to a surfactant under basic conditions, and further wherein the emulsion has a second viscosity that is less than the first viscosity of the liquid crude hydrocarbon fraction; and (b) breaking the emulsion by contacting the emulsion with a carbon dioxide-containing material as to convert at least a portion of the surfactant to the oil-soluble compound.

In general, an emulsion obtained in step (a) of the method of the present invention includes an aqueous fraction and a liquid crude hydrocarbon fraction and is ordinarily an oil-in-water emulsion. The term “oil-in-water” emulsion has a meaning that is conventionally known in the art, and refers to an emulsion in which the water phase is the continuous phase and the oil phase is the dispersed phase.

The oil phase, i.e., the liquid crude hydrocarbon fraction, contains a number of hydrocarbon materials that are typically present in oil-in-water emulsions, the selection of which is known to those skilled in the art. Generally, the source of the produced viscous liquid crude hydrocarbon may be any source wherefrom a hydrocarbon crude may be obtained, produced, or the like. The source may be one or more producing wells in fluid communication with a subterranean oil reservoir. The producing well(s) may be under thermal recovery conditions, or the producing well(s) may be in a heavy oil field where the hydrocarbon crude or oil is being produced from a reservoir having a strong water-drive.

In one embodiment, the oil phase includes an oil such as a crude oil, e.g., a heavy or light crude oil, bitumens and combinations thereof. Crude oil is any type of crude oil or petroleum and may also include liquefied coal oil, tar sand oil, oil sand oil, oil shale oil, Orinoco tar or mixtures thereof. The crude oil includes crude oil distillates, hydrocarbon oil residue obtained from crude oil distillation or mixtures thereof. The term “heavy oil” as used herein refers to a crude oil having an API gravity less than about 20 and a viscosity higher than about 100 centistokes (cSt) to about 1,000,000 cSt at 40° C. An example of a heavy crude oil includes hamaca bitumen crude oil. A heavy crude oil has a relatively high asphaltene content with a relatively low hydrogen/carbon ratio. The term “light oil” as used herein refers to crude oil having an API gravity higher than 20 and a viscosity less than 100 cSt at 40° C. A light crude oil has a relatively low asphaltene content with a relatively high H/C ratio.

The viscous liquid crude hydrocarbon will contain at least one oil-soluble compound capable of being converted to a surfactant under basic conditions. Generally, the oil-soluble compounds are inactive surfactants which, when activated, are natural surfactants. The inactive surfactants are ordinarily activated by a buffer additive, as discussed hereinbelow, which is added to the emulsion. The basic nature of the emulsion is believed necessary for the activation of the inactive surfactants, and the buffering helps to maintain the pH at a level despite conditions to which the emulsion may be subjected which would normally cause the pH to fluctuate and, therefore, destabilize the emulsion. Representative examples of such oil-soluble compounds include carboxylic acids such as normal aliphatic acids, e.g., nonanoic, octanoic, heptanoic acids and the like, 5 or 6 membered ring cyclic saturated carboxylic acids, polycyclic naphthenic mono- and diaromatic carboxylic acids, terpenoid dicarboxylic acids and the like; phenols; phenols with additional naphthenic rings; naphthols with one or two extra naphthenic rings, thiols and the like and mixtures thereof.

The aqueous phase, i.e., the aqueous fraction, includes at least water. The term “water” includes any form of water such as, for example, deionized water, tap water, distilled water, ground water and the like and combinations thereof. In one embodiment, the aqueous fraction includes water produced from a subsurface hydrocarbon reservoir. The aqueous phase may include any number of different additives (e.g., scale inhibitors, corrosion inhibitors, H₂S scavengers, and biocides), and the like. In one embodiment, the aqueous fraction is substantially free of lignin. In another embodiment, the aqueous fraction is substantially free of amidine and guanidine. The term “substantially free” as used herein shall be understood to mean trace amounts, e.g., less than about 0.001 wt. %, if any of each of lignin, amidine and guanidine.

The emulsion is formed by mixing an aqueous solution and viscous liquid crude hydrocarbon under basic conditions. In general, the aqueous solution should have a pH above about 10. In one embodiment, the aqueous solution should have a pH above about 10 and no more than about 14. In another embodiment, the aqueous solution should have a pH above about 10 and no more than about 13. Typically, a buffer additive capable of providing an aqueous solution having a pH above about 10 is first added to the water and mixed. As one skilled in the art would readily understand, some aqueous solutions may have a pH above about 10. Thus, it may not be necessary to add a buffer additive to the aqueous solution. However, it is advantageous to add a buffer additive to the aqueous solution so long as the pH is no more than about 14. The function of the buffer additive is to raise the pH of the aqueous solution to provide a basic aqueous buffer solution, extract the inactive surfactants from the viscous liquid crude hydrocarbon, and to activate the surfactant so as to provide an active natural surfactant for stabilizing the emulsion. For example, the activation of a natural surfactant (e.g., HAc) can be based on the following chemical reaction with Na₂CO₃:

2HAc+Na₂CO₃→2Ac⁻+2Na⁺+2H⁺+CO₃²⁻

During this reaction, the anionic form of the natural surfactants (Ac) is produced which is the interfacial active specie and used to stabilize the oil-in-water emulsion.

Suitable buffer additives include, but are not limited to, alkali metal carbonates, alkali metal bicarbonates, organic amines and mixtures thereof. Representative examples of alkali metal carbonates include lithium carbonate, sodium carbonate, potassium carbonate and the like and mixtures thereof. Representative examples of alkali metal bicarbonates include lithium bicarbonate, sodium bicarbonate, potassium bicarbonate and the like and mixtures thereof. Suitable organic amines include any primary, secondary or tertiary amines, hydroxyl amines, aromatic amines, ammonia and the like and mixtures thereof. Representative examples of such amines include diisopropylethylamine, diethylamine, triethylamine, tributylamine, ethanolamine, aniline, trimethyl aniline, o-toluidine, p-toluidine, methyl phenyl amine, and the like and mixtures thereof.

The buffering of the pH also generally serves to prevent a breaking of the emulsion due to changes in pH which may be caused by pumping, handling, pressure and temperature surges and mixing. Further, the buffer additive can provide the desired pH of the aqueous solution over a broad range of concentration of the buffer additive in the aqueous buffer solution. Thus, changes in the concentration of the buffer additive, which are to be expected over time, do not result in an aging and breaking of the emulsion. The buffer additive is ordinarily present in an amount of between about 500 ppm and about 10,000 ppm, based on the weight of the liquid hydrocarbon fraction. In one embodiment, an organic amine buffer additive is present in an amount of about 5,000 ppm and about 7,000 ppm, based on the weight of the liquid hydrocarbon fraction. In another embodiment, sodium carbonate buffer additive is present in an amount of about 1,500 ppm and about 3,000 ppm, based on the weight of the liquid hydrocarbon fraction.

The aqueous buffer solution is then mixed with the viscous liquid crude hydrocarbon at a mixing rate sufficient to provide an emulsion of the viscous liquid crude hydrocarbon (dispersed phase) in the aqueous buffer solution (continuous phase) having a desired viscosity, whereby the buffer additive converts the oil-soluble compound to a surfactant from the viscous crude hydrocarbon into the aqueous buffer solution so as to stabilize the emulsion. Any conventional mixer known in the art can be employed. In one embodiment, the aqueous buffer solution and viscous liquid crude hydrocarbon are mixed under heat at a temperature ordinarily ranging from about 60° C. to about 80° C.

In general, the emulsion thus formed will have a viscosity that is less than the viscosity of the liquid crude hydrocarbon fraction. In one embodiment, the viscosity of the emulsion is from about 10 to about 1000 cSt at a temperature of 30° C. In another embodiment, the viscosity of the emulsion is less than or equal to about 350 cSt at a temperature of 30° C. As one skilled in the art will readily appreciate, the resulting emulsion should be sufficiently stable in order to be transported through the pipeline but not so stable that it can not be broken upon reaching its destination, e.g., the emulsion should be stable enough over a two week to four week time period to provide ample time to be transported to its destination. One skilled in the art can readily determine such stability depending on such factors as, for example, diameter of the pipe, distance to transport the emulsion, the crude oil, etc.

In one embodiment, the viscous liquid crude hydrocarbon and aqueous buffer solution are mixed at a ratio, by weight, of viscous liquid crude hydrocarbon to aqueous buffer solution of about 20/80 and about 80/20. In another embodiment, the viscous liquid crude hydrocarbon and aqueous buffer solution are mixed at a ratio, by weight, of viscous liquid crude hydrocarbon to aqueous buffer solution of about 65/35 to about 80/20.

As one skilled in the art will readily appreciate, the emulsion may be formed at any convenient and desirable location along the production path of the viscous liquid crude hydrocarbon. For example, the emulsions can be formed downhole, or at the well head, at collecting stations serving multiple wells or along the pipeline transporting the viscous liquid crude hydrocarbon. However, due to the highly viscous nature of the crude hydrocarbon, it is preferable to form the emulsion as soon as possible so as to easily transport the viscous liquid crude hydrocarbon through a pipeline to its desired location.

Once the emulsion has reached its desired location through the pipeline, the emulsion is then broken by contacting the emulsion with a carbon dioxide-containing material to deactivate the surfactant, i.e., to convert at least a portion of the surfactant to the oil-soluble compound. The carbon dioxide may be employed in the carbon dioxide-containing material in a liquid phase, supercritical phase, gas phase, or solid phase (e.g., dry ice).

If desired, the carbon dioxide-containing material may include a co-solvent to increase the density difference between the oil phase and aqueous phase. A wide variety of co-solvents can be used and include, by way of example, cycloalkyl hydrocarbon solvents such as cyclohexane and the like; aromatic hydrocarbon solvents benzene, xylene, toluene and the like; petroleum cuts such as kerosene, naphtha, gasoline, and the like; and mixtures thereof. The co-solvents may be used in various amounts which can be determined by one skilled in the art. In one embodiment, the carbon dioxide-containing material can contain from about 0 weight/volume percent to about 20 weight/volume percent of co-solvent based on the volume of the emulsion.

The step of breaking the emulsion may take place over various time periods, the selection of which may be determined by one skilled in the art. For example, the emulsion can be broken at any downstream operation or facility such as a refinery unit, ship terminal or electricity generating unit. The amount of carbon dioxide necessary to break the emulsion can be determined by one skilled in the art, e.g., at least about 1 mole of carbon dioxide per about one mole of buffer additive (e.g., sodium carbonate) can be used. In one embodiment, an excess of carbon dioxide can be used. Generally, it is necessary to add enough carbon dioxide per mole of buffer additive in order to change the pH of the aqueous fraction of the emulsion to below the about 10 to about 14 range and deactive the natural surfactant. For example, deactivation of the surfactant using carbon dioxide can be as follows:

CO₂+H₂O→CO₃²⁻+2H⁺ (1)

H⁺+Ac⁻HAc (2)

The emulsion is broken by contacting the carbon dioxide-containing material with the emulsion for a time period ordinarily ranging from about 1 minute to about 10 hours. In another embodiment, the step of contacting the carbon dioxide-containing material with the emulsion is carried out for a time period ranging from about 1 minute to about 2 hours. The step of breaking the emulsion will produce an aqueous fraction having a pH of at least about 5.

Once the emulsion is broken, the aqueous phase and oil phase can be separated using conventional techniques. For example, the aqueous phase and oil phase can be separated employing static or electrostatic separators, desalters and the like.

The following non-limiting examples are illustrative of the present invention.

### Example 1

### Preparation of Oil-in-Water (O/W) (70/30) Emulsions Using Sodium Carbonate in Deionized Water and Heavy Crude Oil A

Characteristics of the Heavy Crude Oil A:

API gravity 7.7

Pour Point (° C.) 28

Asphaltene content 8.7%

Viscosity at 40° C. (cSt) 65689

Sample Preparation

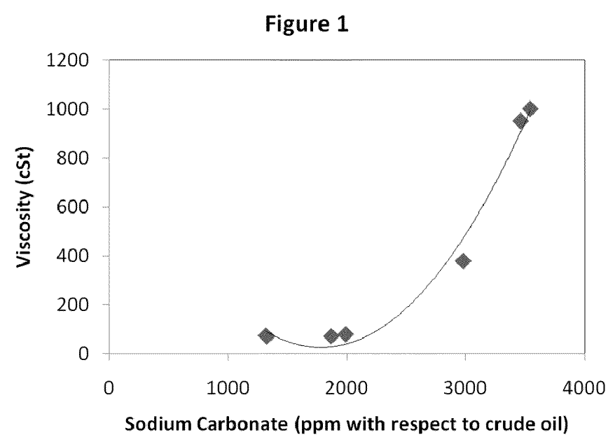

The heavy crude oil A was heated for approximately 20 minutes in a stove at 60° C. Sodium carbonate was dissolved in deionized water and the aqueous solution was heated at 60° C. and kept at this temperature using a water jacket. A sample of the hot crude oil was added slowly to the aqueous solution while the whole mixture was vigorously agitated using a homogenizer at 2500 rotations per minute (RPM). This procedure produced an O/W emulsion for the whole range of concentrations shown in FIG. 1. The O/W ratio of each emulsion was 70/30.

Once the emulsion samples were ready, the procedure described in ASTM D446 was used to evaluate the viscosity of the emulsions at 30° C. FIG. 1 shows the effect of sodium carbonate concentration on emulsion viscosity by plotting the additive concentration as ppm with respect to the crude oil. The data in FIG. 1 confirms the formation of O/W emulsions with adequate viscosity to be transported through a pipeline.

### Example 2

### Preparation of O/W (70/30) Emulsions Using Ethanolamine in Deionized Water and Heavy Crude Oil A

Characteristics of the Heavy Crude Oil A:

API gravity 7.7

Pour Point (° C.) 28

Asphaltene content 8.7%

Viscosity at 40° C. (cSt) 65689

Sample Preparation

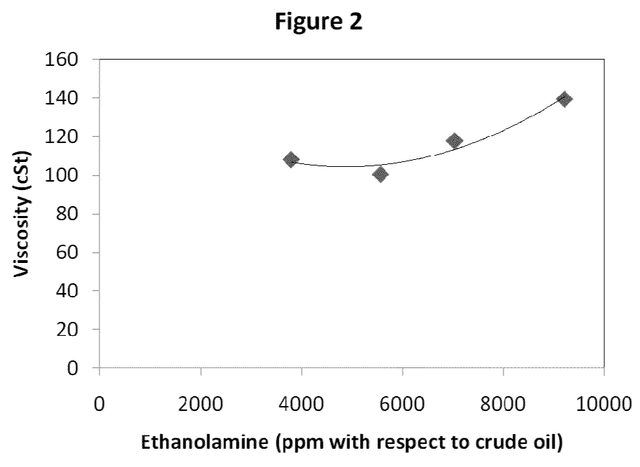

The heavy crude oil A was heated for approximately 20 minutes in a stove at 60° C. Ethanolamine was dissolved in deionized water and the aqueous solution was heated at 60° C. and kept at this temperature using a water jacket. A sample of the hot crude oil was added slowly to the aqueous solution while the whole mixture was vigorously agitated using a homogenizer at 2500 RPM. This procedure produced an O/W emulsion for the whole range of concentrations shown in FIG. 2. The O/W ratio of each emulsion was 70/30.

Once the samples were ready, the procedure described in ASTM D446 was used to evaluate the viscosity of the emulsions at 30° C. FIG. 2 shows the effect of ethanolamine concentration on emulsion viscosity by plotting the additive concentration as ppm with respect to the crude oil. The data in FIG. 2 confirms the formation of O/W emulsions with adequate viscosity to be transported through a pipeline.

### Example 3

Sodium carbonate in different water types

This example was carried out using the same crude oil and procedure as in Example 1.

Emulsions were prepared containing 2000 ppm of sodium carbonate with respect to crude oil in four different water types: deionized water, distillated water, regular tap water and a solution of 10,000 ppm of sodium chloride in de-ionized water. The O/W ratio for each of the emulsions was 75/25.

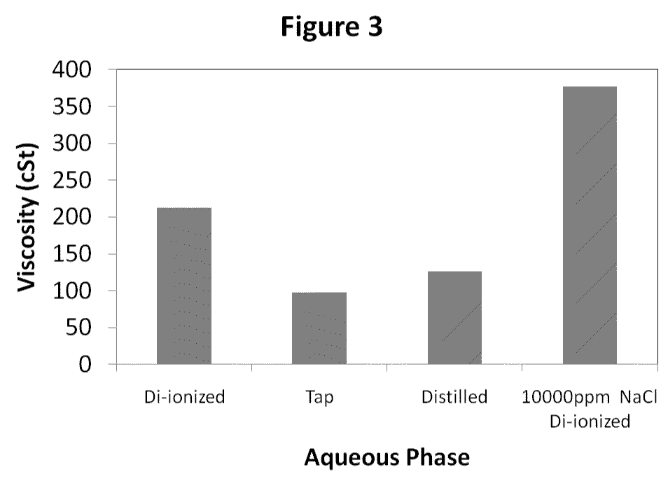

The procedure described in ASTM D446 was then used to evaluate the viscosity of each emulsion at 30° C. FIG. 3 shows the effect of the different aqueous phases on the emulsion viscosity. This data confirms that it is possible to use different aqueous phases to produce transportable emulsions using sodium carbonate.

### Example 4

Aging of Emulsion

This example was carried out using the same crude oil, deionized water and procedure as in Example 1.

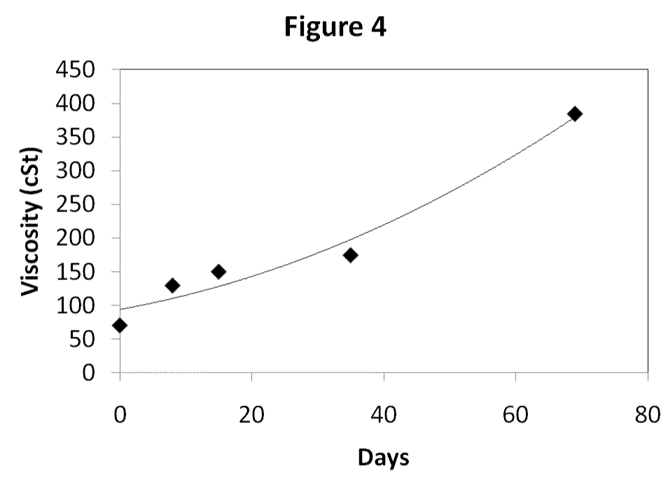

An emulsion was prepared containing 2000 ppm of sodium carbonate with respect to crude oil. The O/W ratio for the emulsion was 70/30. The viscosity was determined several times during more than 2 months using ASTM D446. FIG. 4 shows the viscosity of the emulsion as a function of the aging. This data indicate that at least during the first month the viscosity of the emulsion was adequate for pipeline transportation. This also indicates that the emulsion formed in this example was stable at least during 1 month after its formation.

### Example 5

Breaking of Emulsion

To 2 mL of freshly prepared emulsion as in Example 4 in a test tube was added 2 mL of toluene and an excess of carbon dioxide was bubbled for 5 minutes. After allowing to stand for 10 to 20 minutes, 0.6 mL of water was separated at the bottom of the test tube.

It will be understood that various modifications may be made to the embodiments disclosed herein. Therefore the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the claims appended hereto.

What is claimed is:

1. A method for handling a viscous liquid crude hydrocarbon, the method comprising the steps of:
(a) obtaining an emulsion comprising an aqueous fraction and a liquid crude hydrocarbon fraction, wherein the liquid hydrocarbon fraction has a first viscosity and contains an oil-soluble compound that reversibly converts to a surfactant under basic conditions, and further wherein the emulsion has a second viscosity that is less than the first viscosity of the liquid hydrocarbon fraction; and
(b) breaking the emulsion by contacting the emulsion with a carbon dioxide-containing material to convert at least a portion of the surfactant to an oil-soluble compound.

2. The method of claim 1, wherein the emulsion has a ratio of the liquid hydrocarbon fraction to the aqueous fraction of about 20/80 and about 80/20.

3. The method of claim 1, wherein the liquid crude hydrocarbon fraction comprises a light crude oil.

4. The method of claim 1, wherein the liquid crude hydrocarbon fraction comprises a heavy crude oil.

5. The method of claim 1, wherein the emulsion in step (a) is obtain by combining a viscous liquid crude hydrocarbon and an aqueous solution, wherein the aqueous solution has a pH above about 10.

6. The method of claim 1, wherein the aqueous solution has a pH above about 10 and is obtained by adding a buffer additive selected from the group consisting of an alkali metal carbonate, an alkali metal bicarbonate, an organic amine, and mixtures thereof to an aqueous solution.

7. The method of claim 6, wherein the alkali metal carbonate is selected from the group consisting of lithium carbonate, sodium carbonate, potassium carbonate and mixtures thereof.

8. The method of claim 6, wherein the alkali metal bicarbonate is selected from the group consisting of lithium bicarbonate, sodium bicarbonate, potassium bicarbonate and mixtures thereof.

9. The method of claim 6, wherein the organic amine is selected from the group consisting of a primary, secondary or tertiary amine, a hydroxyl amine, an aromatic amine, and mixtures thereof.

10. The method of claim 6, wherein the organic amine is selected from the group consisting of diisopropylethylamine, diethylamine, triethylamine, tributylamine, ethanolamine, aniline, trimethyl aniline, o-toluidine, p-toluidine, methyl phenyl amine and mixtures thereof.

11. The method of claim 6, wherein the buffer additive comprises sodium carbonate.

12. The method of claim 6, wherein the buffer additive is present in the emulsion in an amount of about 500 ppm and about 10,000 ppm, based on the weight of the hydrocarbon fraction.

13. The method of claim 1, wherein the aqueous fraction comprises water produced from a subsurface hydrocarbon reservoir.

14. The method of claim 1, further comprising the step of transporting the emulsion through a pipeline prior to contacting the emulsion with the carbon dioxide-containing material.

15. The method of claim 8, wherein the second viscosity is less than or equal to about 350 centistokes.

16. The method of claim 1, wherein the step of breaking the emulsion produces an aqueous fraction having a pH of at least about 5.

17. The method of claim 1, wherein the carbon dioxide-containing material contains a co-solvent.

18. The method of claim 17, wherein the co-solvent is selected from the group consisting of a cycloalkyl hydrocarbon solvent, an aromatic hydrocarbon solvent, and mixtures thereof.

19. The method of claim 17, wherein the co-solvent is selected from the group consisting of cyclohexane, benzene, toluene, xylene, and mixtures thereof.

20. The method of claim 1, wherein the step of breaking the emulsion comprises contacting the carbon dioxide-containing material with the emulsion for about 1 minute to about 10 hours.

21. The method of claim 1, further comprising the step of separating the aqueous fraction from the liquid hydrocarbon fraction after breaking the emulsion.

22. The method of claim 1, wherein the aqueous fraction is substantially free of lignin.

23. The method of claim 1, wherein the aqueous fraction is substantially free of amidine and guanidine.

24. The method of claim 1, wherein the emulsion is an oil-in-water emulsion.
